(19) United States
(12) Patent Application Publication
(10) Pub. No.: US 2003/0236838 A1
(43) Pub. Date: Dec. 25, 2003

(54) Shared and private node workflow system

(76) Inventor: Norman Ken Ouchi, San Jose, CA (US)

Correspondence Address: N.K. OUCHI, 20248 VIEWCREST CT, SAN JOSE, CA, 95120, US

(21) Appl. No.: 10/120,086

(22) Filed: Apr. 9, 2002

(51) Int. Cl. G06F 15/16

(52) U.S. Cl. 709/205; 705/9

(57) ABSTRACT

This invention is related to a workflow system, and more particularly to a workflow system with a route where the route defines the sequence of workflow nodes, the process steps and assignment of users, to control the steps of a business process. The route designates a specific user to process the node (a private node) or designates that any user in a set of users can process the node (a shared node). The workflow system provides a user with a queue of active nodes that are to be processed by the user from which the user can select the node to process. The queue can include both private nodes and shared nodes. When a user selects a shared node to process, the node is removed from the queues of other user that share the shared node. The route can designate that the user that processes the first node in a sequence of shared nodes processes all the nodes in the sequence of shared nodes.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A MICROFICHE APPENDIX

Not applicable

### TECHNICAL FIELD

This invention is related to a workflow system, and more particularly to a workflow system with a route where the route defines the sequence of workflow nodes, the process steps and assignment of users, to control the steps of a business process.

### BRIEF SUMMARY OF THE INVENTION

In the present invention, a workflow system has a route that defines a sequence of nodes where each node defines a work step and user to process the step. The user can be a person or a computer with a program to perform the step. The route designates a specific user to process the node (a private node) or designates that any user in a set of users can process the node (a shared node). The workflow system provides a user with a queue of active nodes that are to be processed by the user from which the user can select the node to process. The queue can include both private nodes and shared nodes. When a user selects a shared node to process, the node is removed from the queues of other user that share the shared node. The route can designate that the user that processes the first node in a sequence of shared nodes processes all the nodes in the sequence of shared nodes.

### BACKGROUND OF THE INVENTION

A business process is a sequence of steps executed by a set of users where each step is assigned to a specific user. In FIG. 1, the business process 1 consists of Step A, Step B, Step C and Step D. To execute the business process 1, a user is assigned to process Step A, another user is assigned to Step B, etc. The business process 1 may have a written procedure but it does not have a mechanism to assure that the steps are processed in the prescribed sequence. A workflow system has a route, a sequence of workflow nodes, to control and track a business process by mapping the sequence of business process steps to a corresponding sequence of nodes in the workflow route and assigning to each node the user responsible for processing of the business process step. In FIG. 1, the workflow route 2 consists of Node A corresponding to business process 1 Step A, Node B corresponding to Step B, etc. Each node 3 is assigned a user 5 and provides a user screen 4 or set of screens to accomplish the business process step. The workflow route begins execution when “Start” initiates and passes “control” to the first node in the route. When control is passed to a node, the node 3 activates the screen 4 for the assigned user 5. The assigned user 5 uses the screen 4 to accomplish the business process step. When the user 5 has completed the process provided by the screen 4, control is passed to the next node in the route. Control is passed in the sequence of nodes designated by the route until a node passes control to “Complete” which terminates the execution of the workflow route. The workflow system does not force the processing of a step on a user. Rather, each user has a queue in which the workflow system places nodes to be processed by the user. The user selects a node from the queue to begin the processing of the step. The user may have more than one node in the queue. The queue may have a priority mechanism that indicates the priority for each step in the queue. To be effective in controlling and tracking a specific business process, the workflow route must match the flow of the business process and assign the appropriate people as users for each node. Creating the route requires an understanding of the business process and the people who execute each of the process steps.

In general, the route is generated before the route is used by the workflow system. That is, the specific sequence of nodes and users are assigned before the business process begins execution. However, it may be difficult to determine a priori the specific user who should process a step. For example, a step could be processed by one of a set of qualified users. Embedding a specific user in the node may not be the most effective execution of the route since that user may be busy when the node is to be processed, another user could have processed the node, and the business process could have been completed sooner. The prior art tried to solve this problem with two different route structures. In the first route structure, a node that could be processed by one user of a set of users was implemented as a parallel set of nodes with one node for each user in the set. The parallel route structure is illustrated in FIG. 2A where Node A is followed by the parallel structure Node B1, Node B2, and Node B3 that is followed by Node C. User A is assigned to Node A, User B1 to Node B1, User B2 to Node B2, User B3 to Node B3 and User C to Node C. Node B1, Node B2, and Node B3 process the same step. User B1, User B2, and User B3 are all qualified to process the step. When the route is initiated, the workflow system places Node A in the queue for User A. User A selects Node A from the User A queue, and performs the step for Node A. The workflow system then places Node B1 in the queue for User B1, Node B2 in the queue for User B2, and Node B3 in the queue for User B3. The first user to select the node from the queue and execute his node completes the parallel nodes for the route and workflow system moves to Node C and places Node C in the User C queue. The route was successful in that the first of the users was able to process the step. However, the second and third users may re-execute the process step and the workflow system or parallel node structure had to be designed so that only one processing of the step was permitted or re-executions tolerated. Another problem is a result of the static assignment of users. The set of qualified users may change between the time the route was created and the route executed. Route maintenance for routes with static user assignment can be very high.

Davis disclosed a second route structure that defined a new type of user, a “team-work-list”. FIG. 2B illustrates a route where Node A is followed by Node B, which is followed by Node C. User A is assigned to Node A, the team-work-list to Node B, and User C to Node C. When the route is initiated, the workflow system places Node A in the list for User A. When User A selects and performs the step for Node A, the workflow system places Node B in the list for the team-work-list. The users that belong to the team-work-list set can view the list for the team-work-list and can move the node into their list and off of the team-work-list queue. Since there is only one node, the re-execution problem is avoided. The route structure is simpler since the parallel structure is not required. The users who can view the team-work-list can be changed as the set of qualified users change. The static assignment of users is avoided and route maintenance is simpler.

While the second route structure has advantages over the parallel route structure, it too has significant problems. In many business processes, the process performed by a user is not a single node but a sequence of nodes before passing the work to another user. The second route structure requires that the user move a node into the user's list, execute the step in the node, and return to the team-work-list list to transfer the next node in the sequence. Also, a second user who can also access the team-work-list could transfer the next node in the sequence to the second user's list and break the sequence started by the first user.

The sequence of nodes may have points where the work can pass to another user with the same capability or can be continued by the original user. The sequence of node must also designate where in the route work can move to another user.

The second route structure requires users to look in all of the lists for which they are members, select the node to process, and move the node into their list. Many queue structures can show the work to be done in a prioritized queue so the most important node is processed next. Each user must decide from among the list to which he has access, the next node to process.

The process of looking in other lists and transferring a node into one's list is work and work that is like that of a programmer and not that of a subject matter process worker.

What is desired is a user interface with a single queue that can be prioritized so the user can pick the next node in the queue and execute the process step for the node. If a node can be executed by a user from a set of users, it should appear in the queue of each of the users and when selected by one of the users, it is removed from the queues of the others. If the same user must execute a sequence of process nodes, the route and the workflow system should present the nodes of the sequence to the user who started the sequence and not to any other user.

### BRIEF DESCRIPTION OF THE DRAWINGS

FIG. 1 illustrates a business process and a workflow route to support the business process.

FIG. 2A illustrates a workflow route with a parallel structure

FIG. 2B illustrates a workflow route with a node with a team-work-list.

FIG. 3A illustrates a workflow route with a node with a set of users.

FIG. 3B illustrates a flow chart for the process to update the user name field for a shared node.

FIG. 4A illustrates a workflow route with a node to repeat the user name of the predecessor node so that the same user processes the sequence of two nodes.

FIG. 4B illustrates a workflow route with two independent sequences of two nodes.

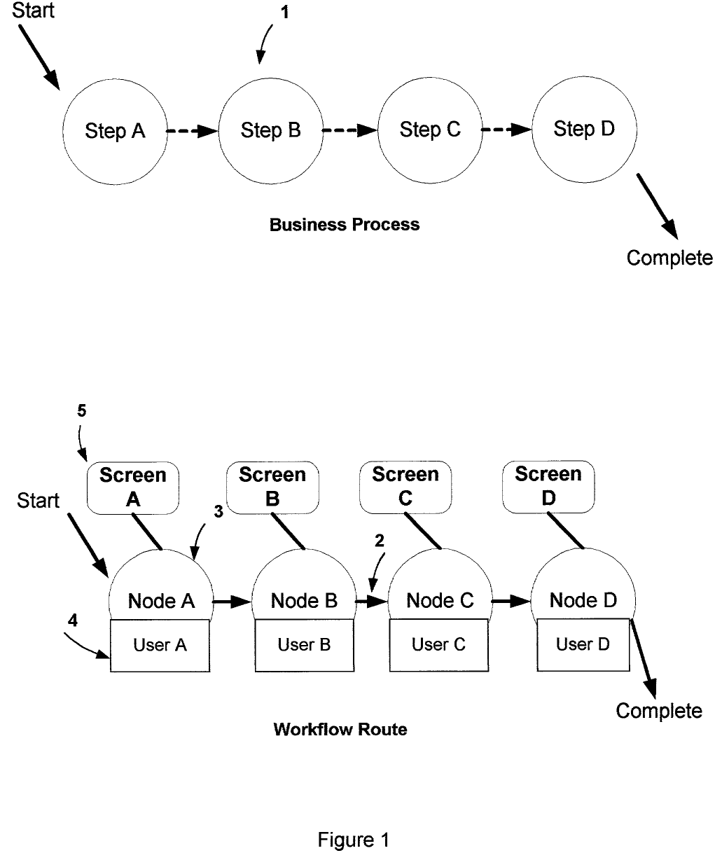

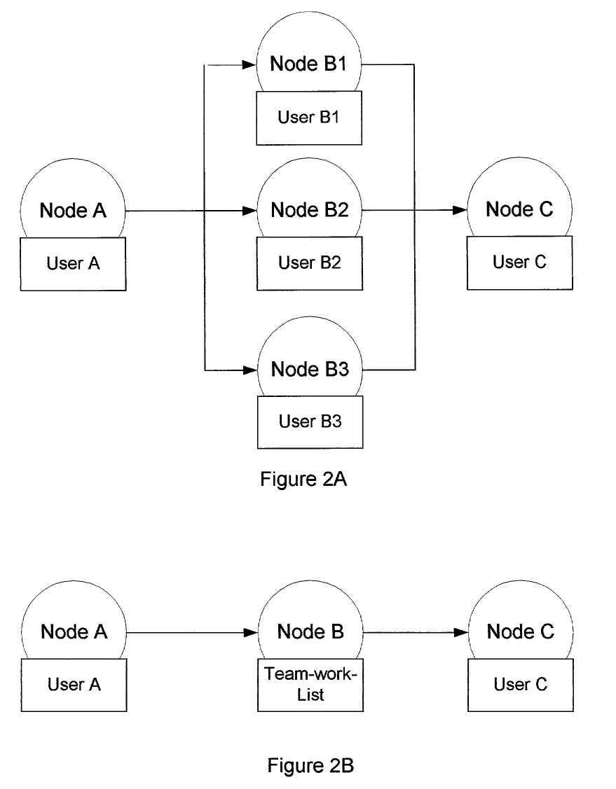

### DESCRIPTION OF THE INVENTION

In the present invention, a workflow system has a route that defines the sequence of nodes where each node defines the process step and user to execute the step. The user can be a person or a computer with a program to perform the step.

A node designates a specific user to process the step in the node (a private node) or designates that any user in a set of users can process the step in the node (a shared node). Each user has a name that is unique in the workflow system. For example, User A or John or Sally Smith are possible names for a user. Each set of users that can have shared nodes has a name that is unique in the workflow system. For example, User Set B or Tag Inspectors or Estimators are possible names for a set of users. There are no special characteristics for these names other than they must be unique. Two users, two sets of users or a user and a set of users cannot have the same name. A route can be represented by a Structured Query Language Table, SQL Table. Table 1 Route Table, illustrates a route, named Route A, with three nodes: Node A, Node B, and Node C and three users: User A, User B, and User C. In Route A, Node A is the initial node and designates User A as the user to process the step. Node B is the next node and designates User B as the user to process the step. Node C is the next node and designates User C as the user to process the step. Each row in Table 1 represents a node in Route A. A row contains values for the columns ROUTE NAME, NODE, USER, and NEXT NODE. The NEXT NODE field designates the node to follow the node in the row. A row with NEXT NODE value DONE indicates the last node in the route and completion of the process.

TABLE 1
Route Table

| ROUTE NAME | NODE | USER | NEXT NODE |
|---|---|---|---|
| ROUTE A | NODE A | USER A | NODE B |
| ROUTE A | NODE B | USER B | NODE C |
| ROUTE A | NODE C | USER C | DONE |

The workflow system has a table of all active routes with the name of the route, the current node, and the name of the user or set of users for each active route. When a route is started, initiated, the name of the route, the initial node and the initial user name or name of the initial set of users are added to the table. Table 2 Active Route Table illustrates a SQL table that implements the function of the active route table. A row in Table 2 Active Route Table represents the state of an active route with values for the fields in the columns ROUTE NAME, NODE, USER, and SHARE LOCK. The SHARE LOCK column will be discussed in a later paragraph. As the route is executed, the Active Route Table entry for the route is used to keep the current state and is updated with each move to the next node in the route. The Active Route Table holds the state of all active routes in the workflow system. The fields in the USER column indicate all of the users for which there is an active node, that is, a node ready for processing or being processed.

TABLE 2
Active Route Table

| ROUTE NAME | NODE | USER | SHARE LOCK |
|---|---|---|---|
| ROUTE A | NODE A | USER A | 0 |

The set of indicators or queue for a given designated name is constructed by selecting the rows with USER column matching the designated name. For example, to construct the queue for USER A, a SQL SELECT statement, SELECT [ROUTE NAME], [NODE], FROM [ACTIVE ROUTE TABLE] WHERE [USER]=“USER A” would return the row ROUTE NAME=ROUTE A and NODE=NODE A. This is the indicator that Node A in Route A is active for User A and can be selected for processing. When USER A selects a node from the USER A queue and completes the node, the workflow system receives the route and the node to select the corresponding row in the Active Route Table. The workflow system uses a SQL SELECT statement, SELECT [NEXT NODE] FROM [ROUTE TABLE] WHERE [ROUTE NAME]=“ROUTE A” AND [NODE]=“NODE A” to return NEXT NODE=NODE B.

The workflow system then uses a SQL SELECT statement SELECT [USER] FROM [ROUTE TABLE] WHERE [ROUTE]=“ROUTE A” AND [NODE]=“NODE B” to return [USER]=USER B. The workflow system then updates the row in the Active Route Table for ROUTE A so that NODE=NODE B and USER=USER B. This indicates that Node B from ROUTE A is in the USER B queue. If the SQL query for NEXT NODE returned DONE, then ROUTE A is complete and the row with ROUTE A is removed from the Active Route Table.

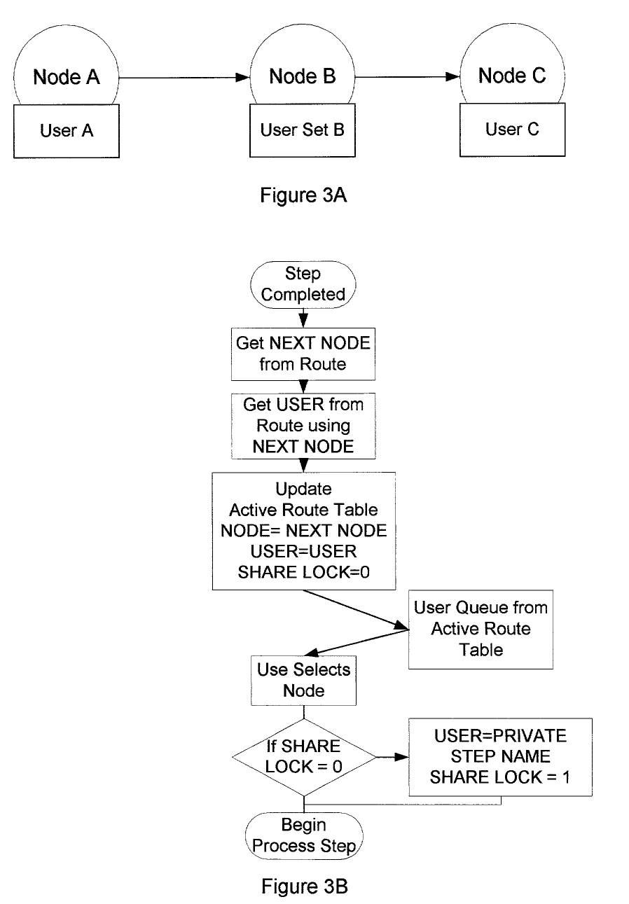

The route with a node that may be executed by a user from a set of users is illustrated in FIG. 3A where the route begins with Node A assigned to User A followed by Node B assigned to User Set B followed by Node assigned to User C. The step at Node A can be processed only by User A and is a private node. The step at Node C is also a private node and can be processed only by User C. Node B is a shared node and any user in User Set B can process the step for Node B. When the step at Node A has been completed, Node B will appear in the queue for all users in User Set B. When the first user in User Set B selects Node B, the shared node, Node B disappears from the queue of all other users in User Set B and cannot be executed by any other user. Each user has a name that is used for private steps and can be a member of any number of user sets. This relationship is illustrated in Table 3 User Names where the relationships between the user name and the named user sets are kept. In Table 3 User Names, User A has the name User A for private nodes, User B1 has User B1 for private nodes and User Set B for nodes shared with other members of User Set B, User B2 has User B2 for private nodes and User Set B for nodes shared with other members of User Set B, User B3 has User B3 for private nodes and User Set B for nodes shared with other members of User Set B, User C has User C for private nodes.

TABLE 3
User Names Table

| USER NAME | NAME IN NODE |
|---|---|
| User A | User A |
| User B1 | User B1 |
| User B1 | User Set B |
| User B2 | User B2 |
| User B2 | User Set B |
| User B3 | User B3 |
| User B3 | User Set B |
| User C | User C |

The queue for a user is constructed by selecting from the Active Route Table using the names in the User Names Table for the user. The queue for User A is constructed by a select query using WHERE [USER]=“User A” that results in all private nodes for User A. The queue for User B1 is constructed by a select query using WHERE [USER}=“User B1” OR [USER]=“User Set B” that results in all private nodes for User B1 and the shared nodes for User Set B. In the route illustrated in FIG. 3A, when User A completes the step at Node A, the USER field for the route in the Active Route Table is updated to User Set B, the SHARE LOCK field is set to 0, and the NODE field is updated to Node B. Node B will appear in the queues for User B1, User B2, and User B3. When User B1 or User B2, or User B3 selects Node B from their queue, Node B disappears from the queues of the other users. For example, User B1 selects Node B; the workflow system tests that the SHARE LOCK field is 0 and then updates the USER field for the route to the private step name of the selecting user, User B1. The SHARE LOCK field is used to assure that this is done only once and is set to 1. The Active Route now has User B1 in the USER field and the queues for User B2 and User B3 no longer show Node B. The beginning of the node processing also tests that the user name matches the user name in the Active Route Table to assure that subsequent users in the shared node set do not accidentally execute the step. The flow chart for these processes are illustrated in FIG. 3B.

Each user sees the active nodes that the user could process in a single queue. The queue can be prioritized so that the node with highest priority for that user can be determined. A shared node appears in the queues of all users who are in the set of users that share the node and when one user selects the node, the node disappears from the queues of all other users.

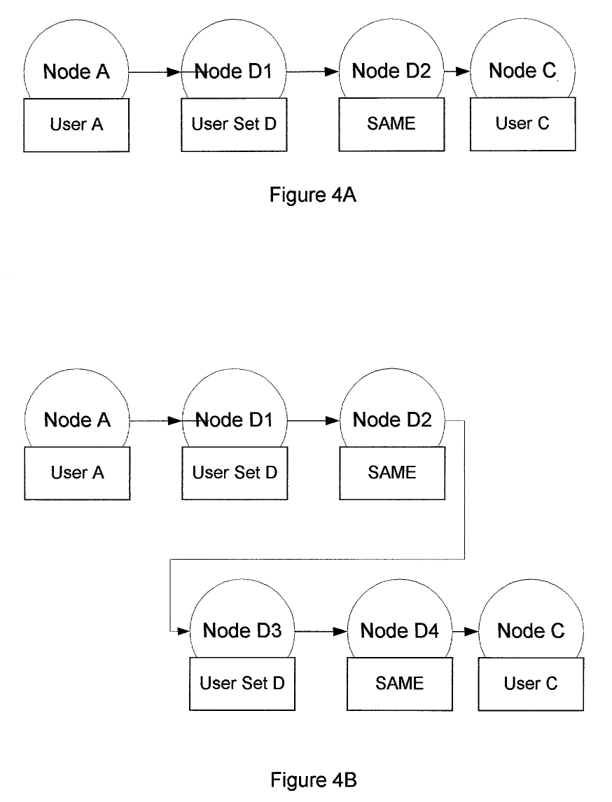

In many business processes, the user must execute a sequence of nodes to complete a business process step before moving the process to another user. The prior art route solutions could not support this requirement. Disclosed is a special user name that is used in the route to indicate that the user name in the Active Route Table is to be used for the node. For example, a process requires that Node A be processed by User A, followed by Node D1 to be processed by any user in User Set D, followed by Node D2 to be processed by the same user in User Set D, followed by Node C to be processed by User C. The user name “SAME” is used to indicate that the active user in the previous node is used for the successor node. Recall that the name in the active route user field was updated to the user that processed the shared node and replaced the name of the set of users, User Set D, from the route. (The workflow can establish any name as the user name to indicate that the user name is to be repeated. To avoid confusion, a user or set of users cannot use the special name used to indicate repeated use of the current name.) A route that uses the special repeat name is illustrated in FIG. 4A. When the workflow system determines the USER for NEXT NODE is “SAME”, then the workflow system does not change the USER field or SHARE LOCK field of the route in the Active Route Table. Since the user for Node D1 was set in the USER field of the Active Route Table, the same user will see Node D2 in his queue after D1 is completed. Other users in User Set D will not see Node D2 in their queue. FIG. 4B illustrates a route where User A is designated to process Node A, Node D1 is to be processed by a user from User Set D, Node D2 is to be executed by the same user, but Node D3 is to be processed by a user from User Set D that may be the same user that processed Node D2 or may be another user from User Set D, Node D4 is to be processed by the same user, and Node C is to be processed by User C. After User A completes Node A, the users in User Set D will see Node D1 in their queue. When a user in User Set D selects Node D1, node D1 disappears from all other user queues. When that user completes Node D2, Node D3 will appear in the queues of the users in User Set D.

The route can designate that the user that processes the first node in a sequence of shared nodes processes all the nodes in the sequence of shared nodes.

### DESCRIPTION OF A PREFERRED EMBODIMENT

A workflow system is a computer program that executes usually on a server that can be, for example, a PC from Dell or Compaq, a workstation or network server from SUN or Hewlett Packard, or a mainframe computer from IBM. The server can provide operating system services using for example, Microsoft Windows NT, Windows 2000, Sun Solaris, Hewlett Packard HP/UX, IBM O/S 9000. Bea Web Logic Process Integrator, Extricity Workflow, IBM MQ Series, IBM Lotus Notes, Oracle Workflow or other workflow system providers provide the basic workflow functions. The organized data for the workflow Route Table, Active Route Table, User Name Table can be implemented with SQL databases as provided by Oracle, Microsoft, and other data base providers. The workflow clients usually execute on a PC, workstation, mainframe terminal, or other computer. However, Personal Digital Assistants, cell phones, two-way pagers, and other devices are now becoming workflow clients. The workflow system may require a workflow client program to execute on the workflow client system but most modern workflow systems only require an Internet Web browser compatible interface or an e-mail compatible interface. Each workflow client has a display and input device such as a keyboard or other means to provide the business process information and means to input the response from the user. The workflow clients are connected to the workflow server using a computer network such as a local area network, a wide area network, the Internet, a virtual private network, wireless networks, etc. Each workflow client has an address on the network by which the workflow server and the client can communicate. Most contemporary workflow systems do not “hard wire” workflow address to a specific user but each user has an “account” or user address that is connected to a specific workflow client address only for a session or transaction. This permits a user to use any compatible physical workflow client and not be tied to a specific piece of hardware. A parallel example is the use of a web based e-mail account where the e-mail user can “log-on” to the user's e-mail account from any web compatible system and transact e-mail functions.

Most contemporary workflow system do not have a hard wired process but have a “route” or similar structure to define the sequence of process steps and the user for each step. Functions described in the present invention can be implemented as modifications to a workflow system. The data base tables and basic algorithms have been described. Those skilled in the art realize that these functions can be implemented in other ways to adopt a workflow system to provide the capabilities of the present invention and not limited to the examples provided in the patent application.

I Claim:

1. A Shared And Private Node Workflow System; a route, a sequence of nodes where a node designates a step and the name of a user (a private node) or the name of a set of users (a shared node) to process the step, a first user, wherein the Shared And Private Node Workflow System uses the route to sequence the processing of the steps by providing to the first user an indicator when a node for which the first user is named or is a member of the named set of users is active.

2. The Shared And Private Node Workflow System of claim 1, a second user that is a member of the same named set of users as the first user, and an active shared node wherein the indicator is removed for the second user when the first user begins processing the shared node.

3. The Shared And Private Node Workflow System of claim 1 wherein the first user is provided a queue of indicators when more than one node for which the first user is named or is a member of the named set of users is active

4. The Shared And Private Node Workflow System of claim 1 wherein the first user is provided a prioritized queue of indicators when more than one node for which the first user is named or is a member of the named set of users is active

5. The Shared And Private Node Workflow System of claim 1 wherein a node in the route designates that the user for the node is the user for the predecessor node when the predecessor node was active.

6. The Shared And Private Node Workflow System of claim 1 wherein the route can designate that the user that processes the first node in a sequence of shared nodes processes all the nodes in the sequence of shared nodes

7. The Shared And Private Node Workflow System of claim 1 wherein a shared node is processed only once.

8. A Workflow System and Route with Shared and Private Nodes and a first user wherein the Route with Shared and Private Nodes provides a sequence of nodes, each node designates a step and the name of a user (private node) or the name of a set of users (shared node) to process the step; and the Workflow System, with an active route table containing a user field with the name of a user or name of a set of users for the active node, uses the Route with Shared and Private Nodes to sequence the processing of the steps by providing to the first user an indicator when a node for which the first user is named or is a member of the named set of users is active.

9. The Workflow System and Route with Shared and Private Nodes of claim 8 wherein the active route user field is updated to the name of the first user when the first user begins processing the node.

10. The Workflow System and Route with Shared and Private Nodes of claim 8 and a second user that is a member of the same named set of users as the first user and an active shared node wherein the active route user field for the shared node is updated to the name of the first user when the first user begins processing the node and the indicator for the second user is removed.

11. The Workflow System and Route with Shared and Private Nodes of claim 8 wherein a node in the route designates that the user for the node is the user in the active route user field and the user field is not changed when the node becomes an active node.

12. The Workflow System and Route with Shared and Private Nodes of claim 8 with an active route share lock field wherein the active route share lock field is used to assure that a shared node is processed only once by
setting the shared lock field to a first state when the name of a set of users is set in the user field and
when a user with a user name selects the node,
testing the shared lock field to be in the first state before the steps of
setting the user field to the user name and
setting the shared lock to a second state
testing that the name of the user that selected the node matches the user name in the user field before processing the node.

13. The Workflow System and Route with Shared and Private Nodes of claim 8 wherein the indicator that a node is active for the first user is determined by matching the first user name or the name of the set of users for which the first user is a member with the name in the user field.

14. The Workflow System and Route with Shared and Private Nodes of claim 8 wherein the indicator that a node is active for the first user is determined by matching the first user name or the name of the set of users for which the first user is a member with the name in the user field and a queue of indicators is provided to the first user.

15. The Workflow System and Route with Shared and Private Nodes of claim 8 wherein the indicator that a node is active for the first user is determined by matching the first user name or the name of the set of users for which the first user is a member with the name in the user field and a prioritized queue of indicators is provided to the first user.

16. A Shared And Private Node Route, a workflow system, and a first user, wherein the Shared And Private Node Route provides a sequence of nodes, where a node designates a step and the name of a user (a private node) or the name of a set of users (a shared node) to process the step, such that the workflow system uses the route to sequence the processing of the steps by providing the first user an indicator when a node for which the first user is named or is a member of the named set of users is active.

17. The Shared And Private Node Route of claim 16 wherein a node specifies that the user name for the node is the user name for the predecessor node when the predecessor node is active.

18. The Shared And Private Node Route of claim 16 wherein The Shared And Private Node Route can designate that the user that processes the first node in a sequence of shared nodes processes all the nodes in the sequence of shared nodes.
